(19) United States
(12) Patent Application Publication
(10) Pub. No.: US 2008/0266531 A1
(43) Pub. Date: Oct. 30, 2008

(54) DISPLAY APPARATUS, ELECTRONIC APPARATUS, AND REFLECTIVE MIRROR MODULE

(75) Inventors: Wen-Liang Wu, Tainan County (TW); Yen-Chen Chen, Tainan County (TW)

Correspondence Address: J C PATENTS, INC., 4 VENTURE, SUITE 250, IRVINE, CA, 92618, US

(73) Assignee: HIMAX DISPLAY, INC., Tainan County (TW)

(21) Appl. No.: 12/101,702

(22) Filed: Apr. 11, 2008

Related U.S. Application Data
(60) Provisional application No. 60/913,544, filed on Apr. 24, 2007.

(51) Int. Cl. G03B 21/28

(52) U.S. Cl. 353/98

(57) ABSTRACT

A display apparatus including a main body and a housing is provided. The main body includes a light source and a light modulator module. The light source is used for providing a beam. The light modulator module modulates the beam according to an electrical image signal. The housing includes a base, an upper cover, and a reflective mirror. The base has an opening for allowing the modulated beam to pass through. The upper cover is pivotally connected to the base. The reflective mirror is disposed on the upper cover. The modulated beam passing through the opening is suitable to be reflected by the reflective mirror. An electronic apparatus and a reflective mirror module are also provided.

### CROSS-REFERENCE TO RELATED APPLICATION

This application claims the priority benefit of U.S.A. provisional application Ser. No. 60/913,544, filed on Apr. 24, 2007. The entirety of the above-mentioned patent application is hereby incorporated by reference herein and made a part of this specification.

### BACKGROUND OF THE INVENTION

1. Field of the Invention

The present invention generally relates to an electronic apparatus and an optical module thereof, in particular, to a display apparatus, an electronic apparatus with projection function, and a reflective mirror module thereof.

2. Description of Related Art

With the progress of technology, diversified electronic projection apparatuses have been widely applied in various occasions, such as presentations, speeches, theatres, audio-visual teachings, interactive teachings, and home theatres. To cater for the demands of the users, the electronic projection apparatuses are designed to have a delicate and chic appearance, and are provided with stands for adjusting the projection angle thereof.

The light output ports of the projection lenses of the conventional electronic projection apparatuses are generally opened at the front side of the housing. Although the projection angles of the electronic projection apparatuses may be changed by the use of the stands, the projection direction is confined within a particular narrow range in the situation that the electronic projection apparatuses remain unmoved. For example, the beam may only be projected forwards within a narrow range, and cannot be projected downwards, leftwards, rightwards, or backwards. Therefore, the occasions and environments of the applications of the electronic projection apparatuses are limited. Particularly, the current electronic projection apparatuses are miniaturized to be applied to portable electronic apparatuses and are always carried to any occasions and environments. Thus, it is the problem in urgent need of solutions to improve the adaptability of the electronic projection apparatuses in various occasions and environments.

### SUMMARY OF THE INVENTION

Accordingly, the present invention is directed to a display apparatus with greater flexible adaptability in various occasions and environments.

The present invention provides an electronic apparatus, in which the transmission direction of the projected image beam can be changed, such that the electronic apparatus is applicable to various occasions and environments.

The present invention provides a reflective mirror module, for making an incident beam propagating in an appropriate direction according to requirements.

The present invention provides a display apparatus, which includes a main body and a housing. The main body includes a light source and a light modulator module. The light source is used for providing a beam. The light modulator module modulates the beam according to an electrical image signal. The housing includes a base, an upper cover, and a reflective mirror. The base has an opening for allowing the modulated beam to pass through. The upper cover is pivotally connected to the base. The reflective mirror is disposed on the upper cover, for reflecting the modulated beam passing through the opening.

In an embodiment of the present invention, the upper cover is suitable for rotating about a transmission path of the modulated beam. Further, the base includes an annular fixed member and an annular movable member.- The annular movable member is connected to the annular fixed member and capable of rotating relative to the annular fixed member, and is also pivotally connected to the upper cover.

In an embodiment of the present invention, the light modulator module is, for example, a liquid crystal panel, and the light source may be a light-emitting diode (LED).

The present invention provides an electronic apparatus suitable for providing an image beam. The electronic apparatus includes a main body and a reflective mirror module. The main body has a housing. The housing has a base with an opening for allowing the image beam to pass through. The reflective mirror module is suitable to be disposed on a transmission path of the image beam so as to change the transmission direction of the image beam. The reflective mirror module includes an upper cover and a reflective mirror. The upper cover is pivotally connected to the base, and suitable for rotating about the transmission path of the image beam. The reflective mirror is disposed on the upper cover, for reflecting the image beam passing through the opening.

In an embodiment of the present invention, the main body includes a mobile phone, a personal digital assistant (P DA), a projector, or a digital camera.

In an embodiment of the present invention, the base includes an annular fixed member and an annular movable member. The annular movable member is connected to the annular fixed member, and capable of rotating relative to the annular fixed member so as to make the upper cover rotate about the transmission path of the image beam, and is also pivotally connected to the upper cover.

Embodiments of the display apparatus and the electronic apparatus are described below.

In an embodiment of the present invention, the annular fixed member is fitted on the annular movable member, and the annular movable member is suitable for rotating inside the annular fixed member.

In an embodiment of the present invention, the annular movable member is fitted on the annular fixed member, and suitable for rotating outside the annular fixed member.

In an embodiment of the present invention, the base includes a plurality of pivots extending in different directions, the upper cover includes a plurality of buckles corresponding to the pivots, and each of the buckles is suitable to be assembled to the corresponding pivot.

In an embodiment of the present invention, the upper cover includes a plurality of pivots extending in different directions, the base includes a plurality of buckles corresponding to the pivots, and each of the buckles is suitable to be assembled to the corresponding pivot.

The present invention further provides a reflective mirror module, which includes a base, an upper cover, and a reflective mirror. The base has an opening for allowing a beam to pass through. The upper cover is pivotally connected to the base, and suitable for rotating about an incident path of the beam. The reflective mirror is disposed on the upper cover, for reflecting the beam passing through the opening.

In the electronic apparatus and the reflective mirror module of the present invention, since the upper cover is pivotally connected to the base and capable of rotating relative to the base, the direction of the beam reflected by the reflective mirror may be changed according to requirements, thus improving the adaptability of the electronic apparatus and the reflective mirror module into various occasions and environments. Further, in the display apparatus of the present invention, since the upper cover is pivotally connected to the base, and the reflective mirror is disposed on the upper cover, the direction of the beam reflected by the reflective mirror may be changed according to requirements, thus improving the adaptability of the display apparatus into various occasions and environments.

In order to make the aforementioned and other objectives, features, and advantages of the present invention comprehensible, embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a schematic three-dimensional view of a display apparatus according to a first embodiment of the present invention.

FIG. 1B is a schematic view of a light path of the display apparatus in FIG. 1A.

FIG. 2A is a schematic three-dimensional view of a base, an upper cover, and a reflective mirror in FIG. 1A.

FIG. 2B shows the upper cover of FIG.1A when covered on the base.

FIG. 3A is a schematic three-dimensional view of a display apparatus according to a second embodiment of the present invention.

FIG. 3B is a schematic view of a light path of the display apparatus in FIG. 3A.

FIG. 4A is a schematic three-dimensional view of a base, an upper cover, and a reflective mirror in FIG. 3A.

FIG. 4B shows the upper cover of FIG. 3A when covered on the base.

FIG. 4C shows an annular movable member of FIG. 3A when rotating relative to an annular fixed member.

FIG. 5A is a schematic three-dimensional view of a display apparatus according to a third embodiment of the present invention.

FIG. 5B is a schematic view of a light path of the display apparatus in FIG. 5A.

FIG. 6 is a schematic three-dimensional view of a base and a reflective mirror module in FIG. 5A.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

### The First Embodiment

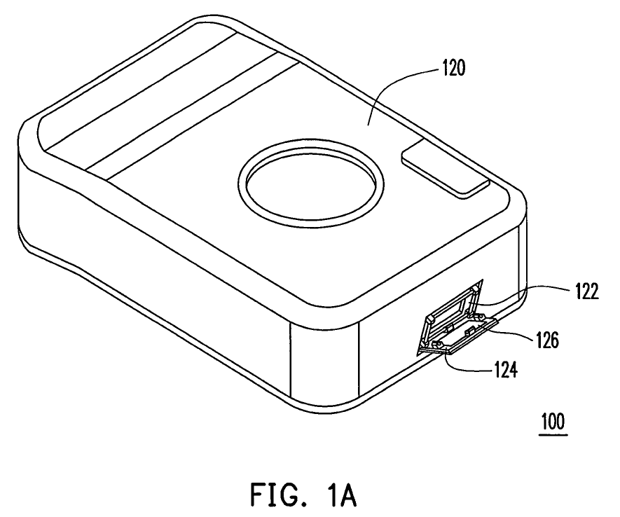

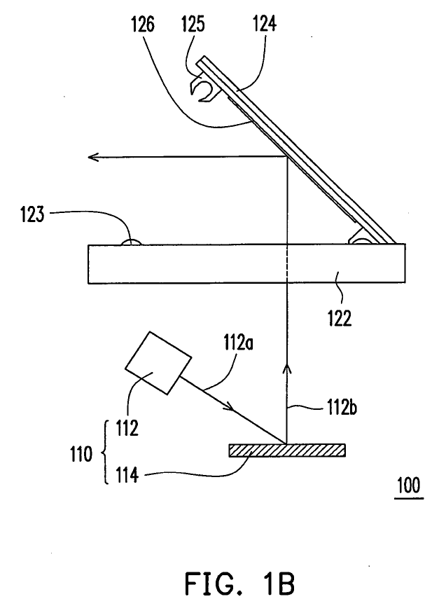

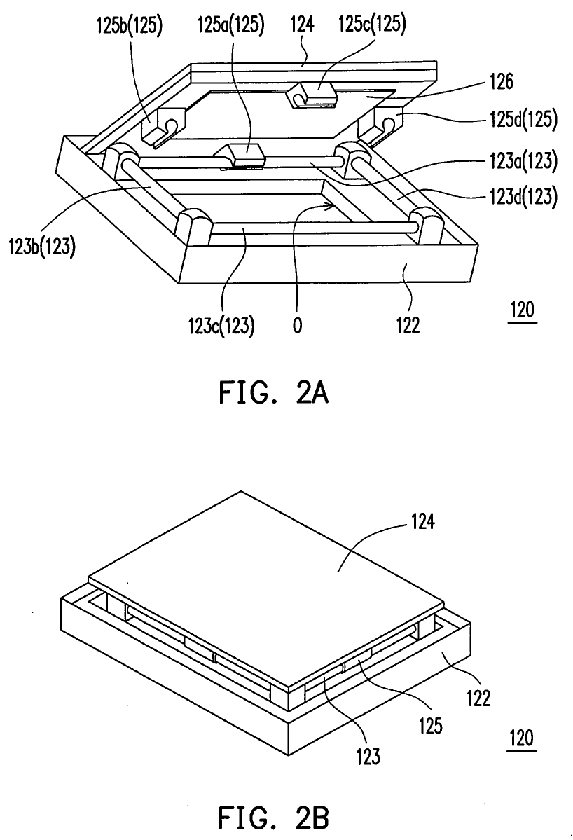

FIG. 1A is a schematic three-dimensional view of a display apparatus according to a first embodiment of the present invention. FIG. 1B is a schematic view of a light path of the display apparatus in FIG. 1A. FIG. 2A is a schematic three-dimensional view of a base, an upper cover, and a reflective mirror in FIG. 1A. FIG. 2B shows the upper cover of FIG. 1A when covered on the base. Referring to FIGS. 1A, 1B, 2A, and 2B, the display apparatus 100 of this embodiment includes a main body 110 (as shown in FIG. 1B) and a housing 120 (as shown in FIG. 1A). The main body 110 includes a light source 112 and a light modulator module 114. The light source 112 is, for example, an LED, for providing a beam 112a. However, in other embodiments, the light source may also be other suitable light-emitting elements. The light modulator module 114 is disposed on a transmission path of the beam 112a, for modulating the beam 112a according to an electrical image signal. In this embodiment, the light modulator module 114 is, for example, a liquid crystal panel, suitable for converting the beam 112a into a modulated beam 112b. In detail, the light modulator module 114 is, for example, a liquid-crystal-on-silicon panel (LCOS panel), suitable for reflecting the beam 112a into a modulated beam 112b. However, in other embodiments, the light modulator module may also be a transmissive liquid crystal panel, such that the beam from the light source may be converted into a modulated beam after passing through the transmissive liquid crystal panel. Alternatively, the light modulator module may also be a digital micro-mirror device (DMD) or other light valves.

The housing 120 includes a base 122, an upper cover 124, and a reflective mirror 126. The base 122 has an opening O (as shown in FIG. 2A) for allowing the modulated beam 112b to pass through. The upper cover 124 is pivotally connected to the base 122. In this embodiment, the base 122 has a plurality of pivots 123 extending in different directions, for example, four pivots 123a, 123b, 123c, 123d as shown in FIG. 2A. The pivots 123a and 123c are substantially parallel to each other, the pivots 123b and 123d are substantially parallel to each other, and the pivots 123a and 123b are substantially perpendicular to each other. Further, the upper cover 124 has a plurality of buckles 125 corresponding to the pivots 123, for example, four buckles 125a, 125b, 125c, 125d corresponding to the pivots 123a, 123b, 123c, 123d as shown in FIG. 2A. Each of buckles 125 is suitable to be assembled to the corresponding pivot 123. The reflective mirror 126 is disposed on the upper cover 124, for reflecting the modulated beam 112b passing through the opening O onto a screen (not shown) or other objects (not shown) suitable for diffusing the modulated beam 112b, so as to form a display image.

In the display apparatus 100, since the upper cover 124 is pivotally connected to the base 122, the upper cover 124 is capable of rotating relative to the base 122 according to requirements, such that the reflective mirror 126 is capable of reflecting the modulated beam 112b to a desired direction. In this way, the direction of the modulated beam 112b reflected by the reflective mirror 126 is changed according to requirements, thus improving the adaptability of the display apparatus 100 into various occasions and environments. In this embodiment, the display apparatus 100 is, for example, a digital camera, suitable to be carried to any occasions and environments, for projecting display images. However, in other embodiments, the display apparatus may also be a mobile phone, a PDA, any other portable electronic apparatus, or a projector.

In addition, when the display apparatus 100 of this embodiment intends to project a display image, the user may open the upper cover 124 from the closed state as shown in FIG. 2B into the state in FIG. 2A, and fasten a buckle 125 (for example, the buckle 125a) and a pivot 123 (for example, the pivot 123a) while releasing other buckles 125 (for example, the buckles 125b, 125c, 125d) from the pivots 123 (for example, the pivots 123b, 123c, 123d). In this way, the modulated beam 112b may be reflected to a desired direction to form a display image. Further, the user may also fasten any one of the buckles 125b, 125c, 125d and the corresponding pivot 123, and release other buckles 125 from the corresponding pivots 123. Thus, the modulated beam 112b may be reflected to more directions. In brief, in this embodiment, the modulated beam 112b may be reflected forwards (from the pivot 123a to the pivot 123c), backwards (from the pivot 123c to the pivot 123a), leftwards (from the pivot 123b to the pivot 123d), and rightwards (from the pivot 123d toward the pivot 123b). In addition, the user may also completely detach the upper cover 124 from the base 122, and thus the modulated beam 122b propagates upwardly (in a direction perpendicular to the plane where the pivots 123a, 123d are disposed) without being reflected by the reflective mirror 126. Therefore, the display apparatus 100 may project a display image in different directions while remaining unmoved, thus improving the adaptability of the display apparatus 100 into various occasions and environments.

It should be noted that, the numbers of the pivots 123 and the corresponding buckles 125 are not limited to the present invention. In other embodiments, the numbers of the pivots and the buckles may also be positive integers greater than 1 except 4. Further, the pivots 123 are not limited to be disposed on the base 122, and the buckles 125 are not limited to be disposed on the upper cover 124 in the present invention. In other embodiments, the pivots may also be disposed on the upper cover, and the buckles may be disposed on the base.

### The Second Embodiment

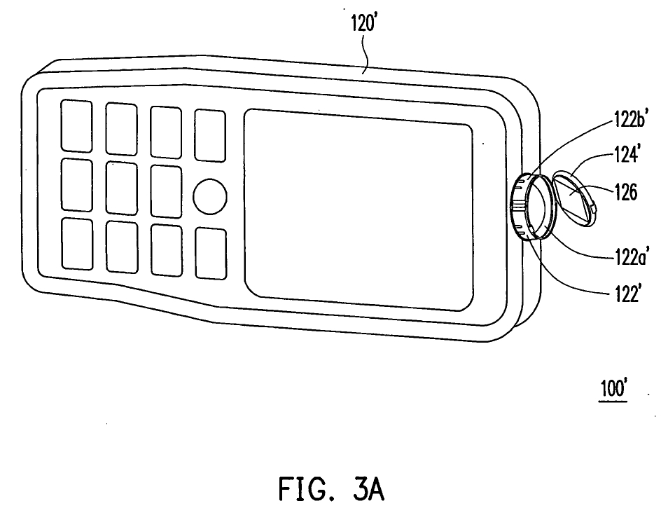

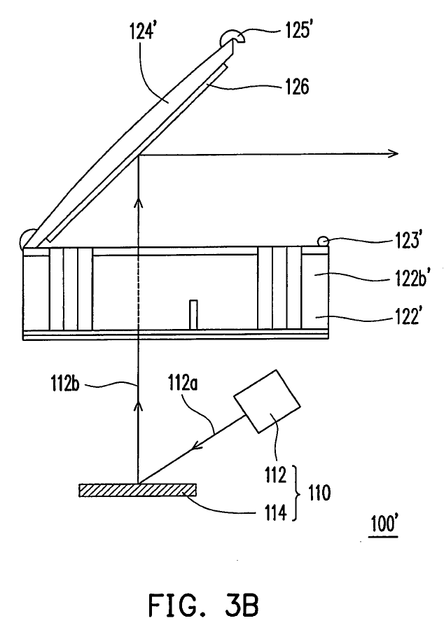

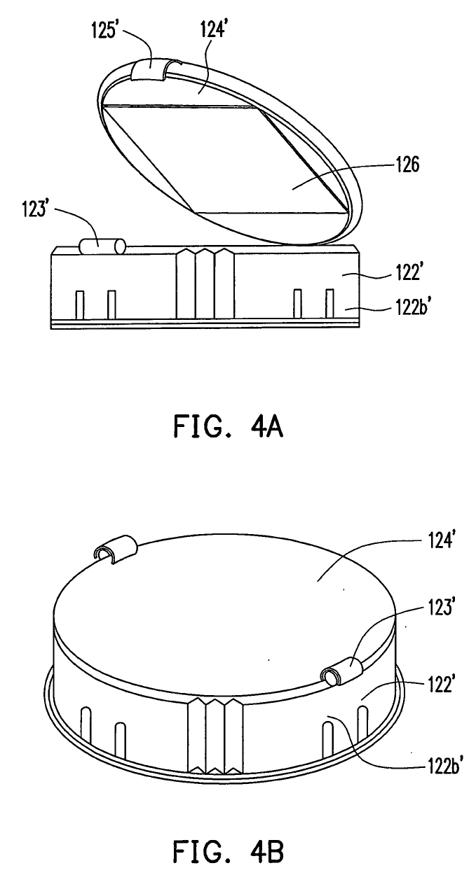

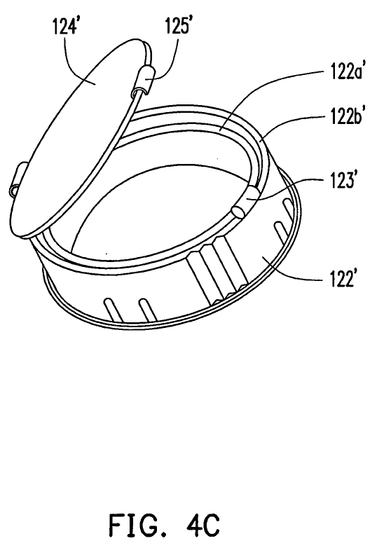

FIG. 3A is a schematic three-dimensional view of a display apparatus according to a second embodiment of the present invention. FIG. 3B is a schematic view of a light path of the display apparatus in FIG. 3A. FIG. 4A is a schematic three-dimensional view of a base, an upper cover, and a reflective mirror in FIG. 3A. FIG. 4B shows the upper cover of FIG. 3A when covered on the base. FIG. 4C shows an annular movable member of FIG. 3A when rotating relative to an annular fixed member. Referring to FIGS. 3A, 3B, and 4A to 4C, the display apparatus 100′ of this embodiment is similar to the display apparatus 100 (as shown in FIG. 1A), while the differences are described as follows. In this embodiment, the display apparatus 100′ is, for example, a mobile phone. Further, in the display apparatus 100′ of this embodiment, the base 122′ of the housing 120′ has an annular fixed member 122a′ and an annular movable member 122b′. The annular movable member 122b′ is connected to the annular fixed member 122a′, and capable of rotating relative to the annular fixed member 122a′, and is also pivotally connected to the upper cover 124′. In detail, the annular movable member 122b′ is fitted on the annular fixed member 122a′, and suitable for rotating outside the annular fixed member 122a′ (as shown in FIG. 4C). Therefore, in this embodiment, the upper cover 124′ is suitable for rotating about a transmission path of the modulated beam 112b. However, in other embodiments, the annular fixed member may also be fitted on the annular movable member, and the annular movable member is suitable for rotating inside the annular fixed member.

In this embodiment, the base 122′ has a plurality of pivots 123′. In detail, the annular movable member 122b′ has a plurality of pivots 123′. The upper cover 124′ has a plurality of buckles 125′ corresponding to the pivots 123′, and each buckle 125′ is suitable to be assembled to the corresponding pivot 123′. However, in other embodiments, the buckles may also be disposed on the annular movable member, and the pivots may be disposed on the upper cover. When the display apparatus 100′ intends to project a display image, the user may open the upper cover 124′ from the closed state as shown in FIG. 4B into the state in FIG. 4A, and fasten a buckle 125′ and the corresponding pivot 123′ while release other buckles 125′ from the corresponding pivots 123′. Further, the user makes the annular movable member 122b′ rotate relative to the annular fixed member 122a′ (as shown in FIG. 4C), such that the modulated beam 122b may be reflected by the reflective mirror 126 to a desired direction. In addition, the user may also completely detach the upper cover 124′ from the base 122′, and thus the modulated beam 122b propagates outwardly without being reflected by the reflective mirror 126. Therefore, the display apparatus 100′ can project a display image in different directions while remaining unmoved, thus improving the adaptability of the display apparatus 100′ into various occasions and environments.

### The Third Embodiment

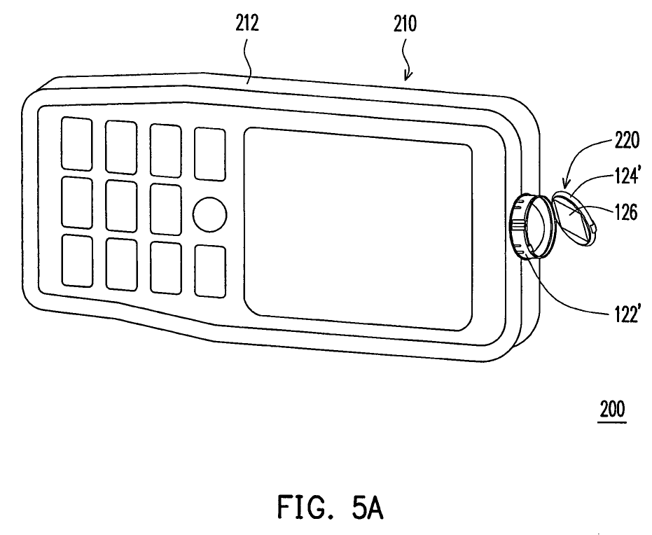

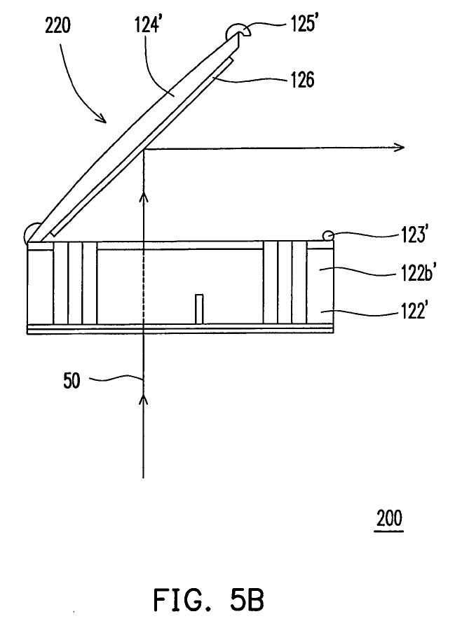

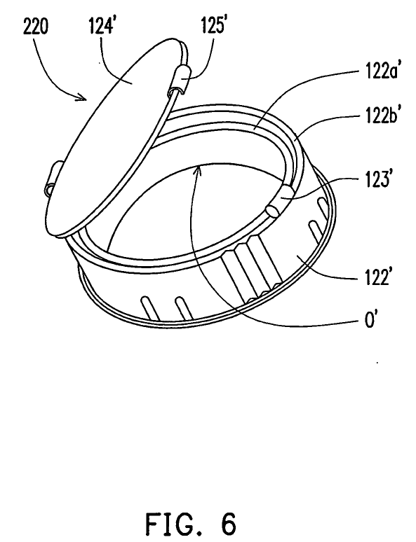

FIG. 5A is a schematic three-dimensional view of a display apparatus according to a third embodiment of the present invention. FIG. 5B is a schematic view of a light path of the display apparatus in FIG. 5A. FIG. 6 is a schematic three-dimensional view of a base and a reflective mirror module in FIG. 5A. Referring to FIGS. 5A, 5B, and 6, the electronic apparatus 200 of this embodiment is, for example, a mobile phone with projection function, suitable for providing an image beam 50. However, in other embodiments, the electronic apparatus may also be a PDA, a digital camera, any other portable electronic apparatus, or a projector. The electronic apparatus 200 has a main body 210 and a reflective mirror module 220. The main body 210 has a housing 212 (as shown in FIG. 5A). The housing 212 has a base 122′ as shown in FIG. 3B, and the base 122′ has an opening O′ (as shown in FIG. 6) for allowing the image beam 50 to pass through. The reflective mirror module 220 includes an upper cover 124′ and a reflective mirror 126 as shown in FIG. 3B. The reflective mirror module 220 is suitable to be disposed on a transmission path of the image beam 50, so as to change the transmission direction of the image beam 50. In detail, the user may open the upper cover 124′ in the manner of the second embodiment. The upper cover 124′ is suitable for rotating about the transmission path of the image beam 50. Thus, the upper cover 124′ may rotate to different positions according to requirements, such that the reflective mirror 126 can reflect the image beam 50 to a desired direction, and project the image. In addition, the user may also completely detach the upper cover 124′ from the base 122′ similar to the second embodiment, and thus the image beam 50 propagates outwardly without being reflected by the reflective mirror 126. In this manner, the electronic apparatus 200 can project the display image in different directions while remaining unmoved, thus improving the adaptability into various occasions and environments.

It should be noted that the base 122′ and the reflective mirror module 220 are not limited to merely change the transmission path of the image beam 50 in the present invention. Actually, the base 122′ and the reflective mirror module 220 may also be externally attached onto or disposed inside other electronic apparatus or optical apparatus to change the transmission path of other beams, such that the transmission direction of the beam may be changed according to requirements.

In view of the above, in the electronic apparatus and the reflective mirror module of the present invention, since the upper cover is pivotally connected to the base and capable of rotating relative to the base, the direction of the beam reflected by the reflective mirror may be changed according to requirements, thus improving the adaptability of the electronic apparatus and the reflective mirror module into various occasions and environments. Further, in the display apparatus according to the embodiments of the present invention, since the upper cover is pivotally connected to the base, and the reflective mirror is disposed on the upper cover, the direction of the beam reflected by the reflective mirror can be changed according to requirements, thus improving the adaptability of the display apparatus into various occasions and environments.

Further, the electronic apparatus and the display apparatus according to the embodiments of the present invention can project the display image in different directions while remaining unmoved. Furthermore, the reflective mirror module according to the embodiments of the present invention can be externally attached to or disposed inside various electronic apparatus or optical apparatus to change the transmission path of different beams, such that the transmission direction of the beam may be changed according to requirements.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A display apparatus, comprising:
a main body, comprising:
a light source for providing a beam;
a light modulator module for modulating the beam according to an electrical image signal so as to form a modulated beam;
a housing, comprising:
a base with an opening for allowing the modulated beam to pass through;
an upper cover pivotally connected to the base; and
a reflective mirror disposed on the upper cover, wherein the reflective mirror is suitable for reflecting the modulated beam passing through the opening.

2. The display apparatus according to claim 1, wherein the base comprises a plurality of pivots extending in different directions, the upper cover comprises a plurality of buckles corresponding to the pivots, and each of the buckles is suitable to be assembled to the corresponding pivot.

3. The display apparatus according to claim 1, wherein the upper cover comprises a plurality of pivots extending in different directions, the base comprises a plurality of buckles corresponding to the pivots, and each of the buckles is suitable to be assembled to the corresponding pivot.

4. The display apparatus according to claim 1, wherein the upper cover is suitable for rotating about a transmission path of the modulated beam.

5. The display apparatus according to claim 1, wherein the base comprises:
an annular fixed member; and
an annular movable member, connected to the annular fixed member and capable of rotating relative to the annular fixed member, and being pivotally connected to the upper cover.

6. The display apparatus according to claim 5, wherein the annular fixed member is fitted on the annular movable member, and the annular movable member is suitable for rotating inside the annular fixed member.

7. The display apparatus according to claim 5, wherein the annular movable member is fitted on the annular fixed member, and suitable for rotating outside the annular fixed member.

8. The display apparatus according to claim 1, wherein the light modulator module is a liquid crystal panel.

9. The display apparatus according to claim 1, wherein the light source is a light-emitting diode (LED).

10. An electronic apparatus, suitable for providing an image beam, comprising:
a main body comprising a housing, wherein the housing comprises a base with an opening for allowing the image beam to pass through;
a reflective mirror module suitable to be disposed on a transmission path of the image beam so as to change a transmission direction of the image beam, and the reflective mirror module comprising:
an upper cover, pivotally connected to the base, wherein the upper cover is suitable for rotating about the transmission path of the image beam; and
a reflective mirror, disposed on the upper cover, wherein the reflective mirror is suitable for reflecting the image beam passing through the opening.

11. The electronic apparatus according to claim 10, wherein the main body comprises a mobile phone, a personal digital assistant (PDA), a projector, or a digital camera.

12. The electronic apparatus according to claim 10, wherein the base comprises a plurality of pivots extending in different directions, the upper cover comprises a plurality of buckles corresponding to the pivots, and each of the buckles is suitable to be assembled to the corresponding pivot.

13. The electronic apparatus according to claim 10, wherein the upper cover comprises a plurality of pivots extending in different directions, the base comprises a plurality of buckles corresponding to the pivots, and each of the buckles is suitable to be assembled to the corresponding pivot.

14. The electronic apparatus according to claim 10, wherein the base comprises:
an annular fixed member; and
an annular movable member, connected to the annular fixed member and capable of rotating relative to the annular fixed member so as to make the upper cover rotate about the transmission path of the image beam, and also being pivotally connected to the upper cover.

15. The electronic apparatus according to claim 14, wherein the annular fixed member is fitted on the annular movable member, and the annular movable member is suitable for rotating inside the annular fixed member.

16. The electronic apparatus according to claim 14, wherein the annular movable member is fitted on the annular fixed member, and suitable for rotating outside the annular fixed member.

17. A reflective mirror module, comprising:
a base with an opening for allowing a beam to pass through;
an upper cover pivotally connected to the base, wherein the upper cover is suitable for rotating about an incident path of the beam; and
a reflective mirror disposed on the upper cover, wherein the reflective mirror is suitable for reflecting the beam passing through the opening.
